(19) United States
(12) Patent Application Publication
(10) Pub. No.: US 2016/0216559 A1
(43) Pub. Date: Jul. 28, 2016

(54) BACKLIGHT MODULE AND DISPLAY APPARATUS USING THE SAME

(71) Applicant: HON HAI PRECISION INDUSTRY CO., LTD., New Taipei (TW)

(72) Inventors: IVAN DE JESUS CAZAREZ LOPEZ, Tijuana (ME); CHIA-CHUN FANG, New Taipei (TW); YU-CHI LI, New Taipei (TW)

(21) Appl. No.: 14/801,193

(22) Filed: Jul. 16, 2015

(30) Foreign Application Priority Data
Jan. 24, 2015 (CN) 201510034842.3

(51) Int. Cl. G02F 1/1335; F21V 8/00

(52) U.S. Cl. CPC G02F 1/133606; G02F 1/133603; G02F 1/133605; G02B 6/0025; G02B 6/0083; G02B 6/003; G02B 6/0073; G02F 2001/133612; G02F 2001/133607

(57) ABSTRACT

A backlight module for providing backlight to a display panel includes a plurality of light sources, a plurality of optical elements corresponding to the light sources, and a circuit board. The circuit board is electrically connected to the light sources, and defines a plurality of predetermined regions corresponding to the optical elements. Each of the predetermined regions includes a plurality of patterns on an upper surface of the circuit board. The patterns in the same predetermined region form a series of concentric rings centered on the corresponding light source. The patterns adjusts a transmitting parameter of the light to be reflected by the corresponding predetermined region.

### CROSS-REFERENCE TO RELATED APPLICATIONS

This application claims priority to Chinese Patent Application No. 201510034842.3 filed on Jan. 24, 2015, the contents of which are incorporated by reference herein.

### FIELD

The subject matter herein generally relates to a backlight module and a display apparatus.

### BACKGROUND

Display apparatuses use light emitting diodes (LEDs) as a light source. Light emitted by the LED pass through a lens to be diffused for illuminating on the display panel. A mura defect appears on an upper location of the lens facing the LED.

### BRIEF DESCRIPTION OF THE FIGURES

Implementations of the present technology will now be described, by way of example only, with reference to the attached figures.

FIG. 1 is a cross-sectional view of a first embodiment of a display apparatus, the display apparatus comprising a circuit board.

FIG. 2 is a plan view of a first embodiment of the circuit board of FIG. 1.

FIG. 3 is a plan view of a second embodiment of the circuit board of FIG. 1

FIG. 4 is a plan view of a third embodiment of the circuit board of FIG. 1.

FIG. 5 is a plan view of a fourth embodiment of the circuit board of FIG. 1.

FIG. 6 is a plan view of a fifth embodiment of the circuit board of FIG. 1.

FIG. 7 is a plan view of a sixth embodiment of the circuit board of FIG. 1.

FIG. 8 is a plan view of a seventh embodiment of the circuit board of FIG. 1.

FIG. 9 is an isometric view of a second embodiment of the display apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a display apparatus for preventing mura defect.

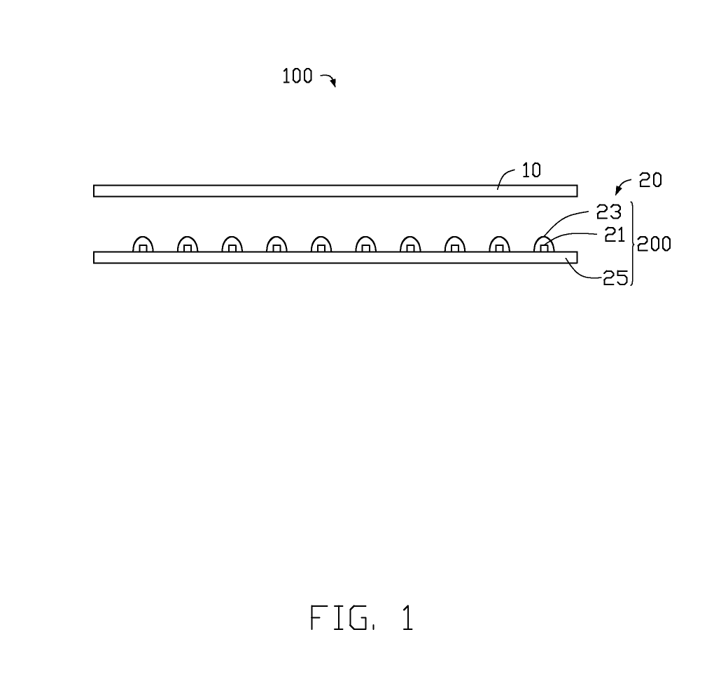

FIG. 1 illustrates a first embodiment of a display apparatus 100. The display apparatus 100 includes a display panel 10 and a backlight module 20. In at least one embodiment, the display apparatus 100 is a direct liquid crystal display apparatus.

The display panel 10 is used for displaying images. The display panel 10 is located on the backlight module 20.

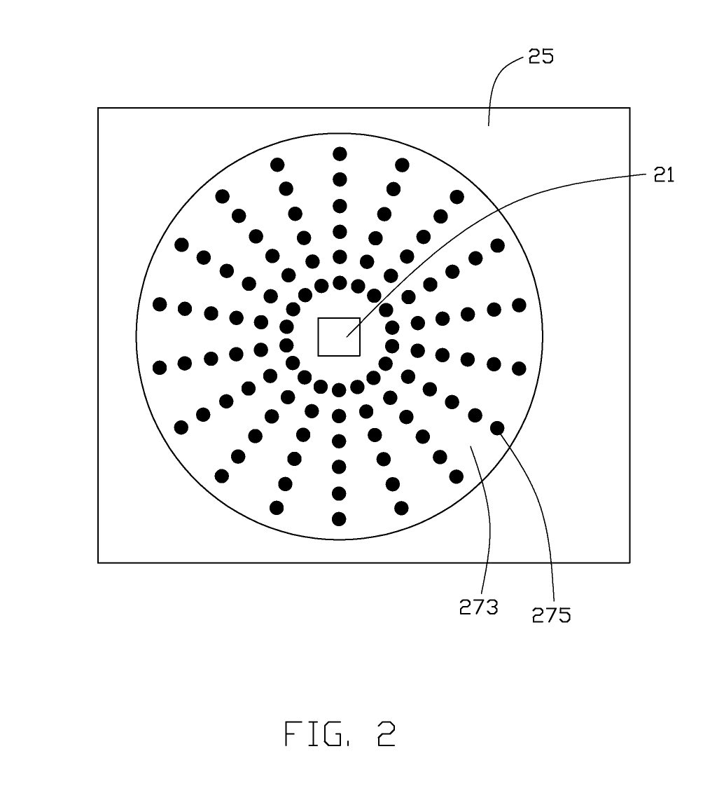

FIG. 2 illustrates a plan view of the backlight module 20. The backlight module 20 is used for providing backlight to the display panel 10. The backlight module 20 includes a plurality of light bars 200 for emitting light. Each of the light bars 200 includes a plurality of light sources 21, a plurality of optical elements 23, and a circuit board 25. The light sources 21 correspond to the optical elements 23 in a one-to-one relationship.

The light source 21 is electrically connected with the circuit board 25. The light source 21 is sandwiched between the corresponding optical element 23 and the circuit board 25. The light source 21 emits light based on a voltage supplied by the circuit board 25. In at least one embodiment, the light source 21 is a light emitting diode (LED).

The optical element 23 is used for diffusing light emitted by the light source 21. The optical element 23 covers the corresponding light source 21. A centre of the light source 21 is located on an axis of the optical element 23. In at least one embodiment, the optical element 23 is a lens.

The circuit board 25 is substantially rectangular shaped. The circuit board 25 defines a plurality of predetermined regions 273. The predetermined regions 273 correspond to the optical elements 23 in a one-to-one relationship. The predetermined region 273 is substantially circle shaped. Each of the predetermined regions 273 includes a plurality of patterns 275 on an upper surface of the circuit board 25. A density of the patterns 275 in the corresponding predetermined region 273 is grandly decreased along a radius direction. The density of the patterns 275 away from the corresponding light source 21 is less than the density of the patterns 275 adjacent to the corresponding light source 21. The patterns 275 form a series of concentric rings centered on the corresponding light source 21. Each of the rings is formed by a common quantity of the patterns 275. The pattern 275 is substantially circle shaped. The pattern 275 includes a plurality of dots. A diameter of the pattern 275 is in a range between 0.3-0.7 millimeters (mm) The pattern 275 is used for adjusting a transmitting parameter of the light to be reflected by the corresponding predetermined region 273. The light illuminated on the predetermined region 273 is a portion of the light emitted by the corresponding light source 21 via the optical element 23. In at least one embodiment, the pattern 275 adjusts a scattering angle of the light. A projection of the optical element 23 on the circuit board 25 is completely overlapping with the corresponding predetermined region 273. The density of the patterns 275 in the predetermined region 273 is in a range between 10%-15%. In other embodiments, the pattern 275 adjusts a reflectivity of the light. The pattern 275 is made of printing ink for decreasing a reflectivity of the light.

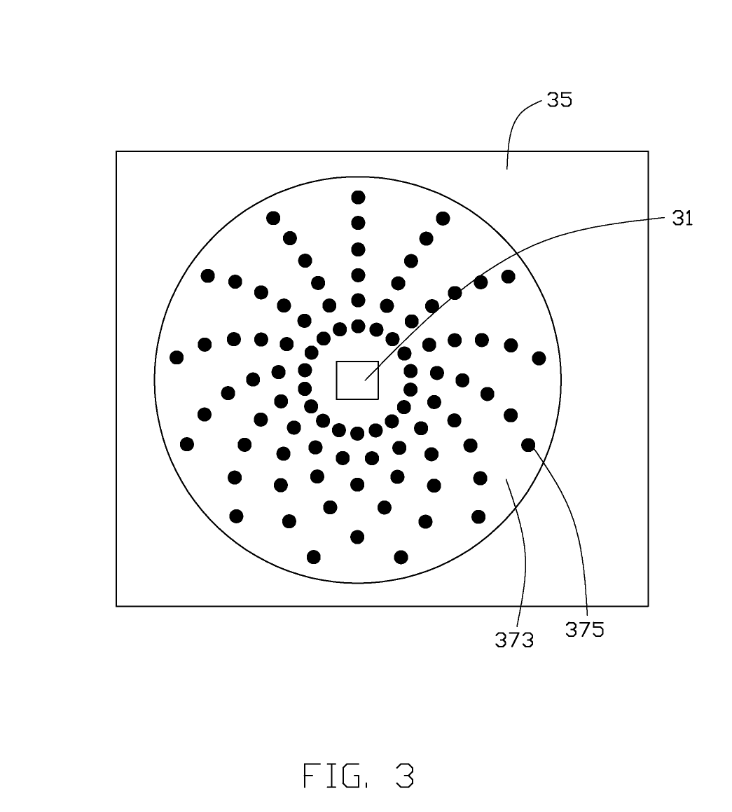

FIG. 3 illustrates a second embodiment of the backlight module 30. The backlight module 30 is used for providing backlight to the display panel 10. The backlight module 30 includes a plurality of light bars 300. Each of the light bars 300 includes a plurality of light sources 31, a plurality of optical elements 33, and a circuit board 35. The light sources 31 correspond to the optical elements 33 in a one-to-one relationship.

The light source 31 is electrically connected with the circuit board 35. The light source 31 is sandwiched between the corresponding optical element 33 and the circuit board 35. The light source 31 emits light based on a voltage supplied by the circuit board 35. In at least one embodiment, the light source 31 is a light emitting diode (LED).

The optical element 33 is used for diffusing light emitted by the light source 31. The optical element 33 covers and is coaxial to the corresponding light source 31. In at least one embodiment, the optical element 33 is a lens.

The circuit board 35 is substantially rectangular shaped and defines a plurality of predetermined regions 373. The predetermined regions 373 correspond to the optical elements 33 in a one-to-one relationship. The predetermined region 373 is substantially circle shaped. Each of the predetermined regions 373 includes a plurality of patterns 375 on an upper surface of the circuit board 35. A density of the patterns 375 in the corresponding predetermined region 373 is grandly decreased along a radius direction. The density of the patterns 375 away from the corresponding light source 31 is less than the density of the patterns 375 adjacent to the corresponding light source 31. The patterns 375 form a series of concentric rings centered on the corresponding light source 31. Quantities of the patterns 375 forming the concentric rings are decreased along a radius direction. The quantity of the patterns 375 forming the ring adjacent to the corresponding light source 31 is larger than the quantity of the patterns 375 forming the ring away from the corresponding light source 31. The pattern 375 is substantially circle shaped. The pattern 375 includes a plurality of dots. A diameter of the pattern 375 is in a range between 0.3-0.7 mm. The pattern 375 is used for adjusting a transmitting parameter of light to be reflected by the corresponding predetermined region 373. The light illuminated on the predetermined region 373 is a portion of the light emitted by the corresponding light source 31 via the optical element 33. In at least one embodiment, the pattern 375 adjusts a scattering angle of the light. A projection of the optical element 33 on the circuit board 35 is completely overlapping with the corresponding predetermined region 373. The density of the patterns 375 in the predetermined region 373 is in a range between 10%-15%. In other embodiments, the pattern 375 adjusts a reflectivity of the light. The pattern 375 is made of printing ink for decreasing a reflectivity of the light.

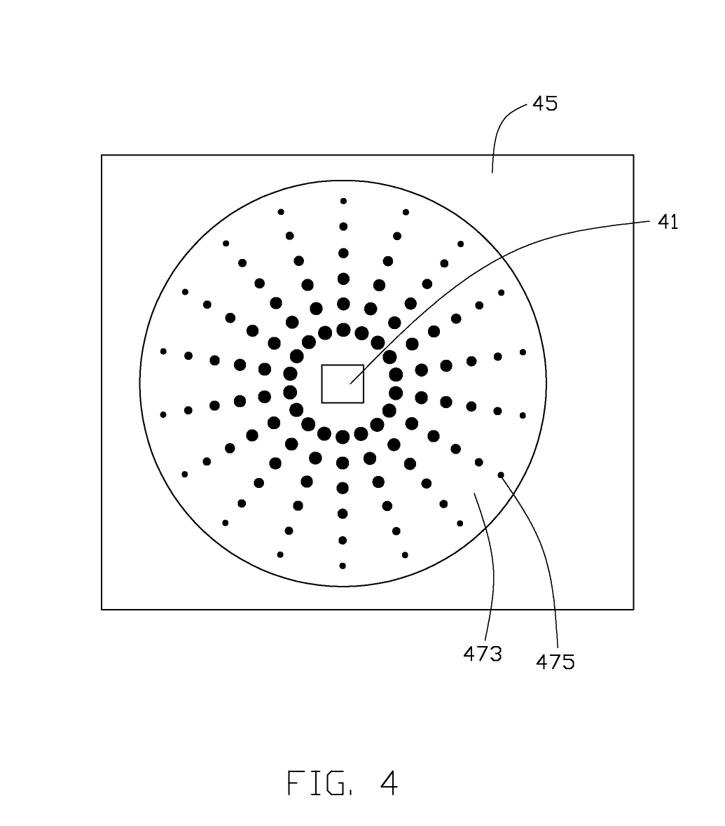

FIG. 4 illustrates a third embodiment of the backlight module 40. The difference between the backlight module 40 and the backlight module 20 is the pattern 475. A density of the patterns 475 in the corresponding predetermined region 473 is grandly decreased along a radius direction. The patterns 475 form a series of concentric rings centered on the corresponding light source 41. Each of the rings is formed by a common quantity of the patterns 475. Diameters of the patterns 475 on the same ring equal each other. Diameters of the patterns 475 on the rings along a radius direction centered on the corresponding light source 41 are grandly decreased. The diameter of the patterns forming the ring adjacent to the corresponding light source 41 is larger than the diameter of the patterns forming the ring away from the corresponding light source 41.

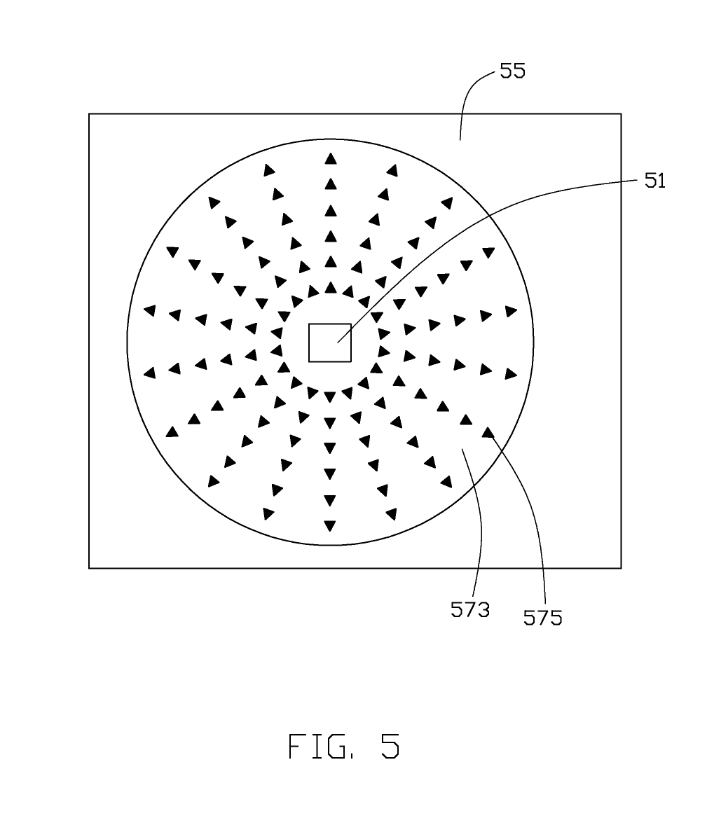

FIG. 5 illustrates a fourth embodiment of the backlight module 50. The difference between the backlight module 50 and the backlight module 20 is the pattern 575. A density of the patterns 575 in the corresponding predetermined region 573 is grandly decreased along a radius direction. The patterns 575 form a series of concentric rings centered on the corresponding light source 51. Each of the rings is formed by a common quantity of the patterns 575. The density of the patterns 575 away from the corresponding light source 51 is less than the density of the patterns 575 adjacent to the corresponding light source 51. The pattern 575 is substantially an equilateral triangle shaped. A side of the pattern 575 is in a range between 0.3-0.7 mm.

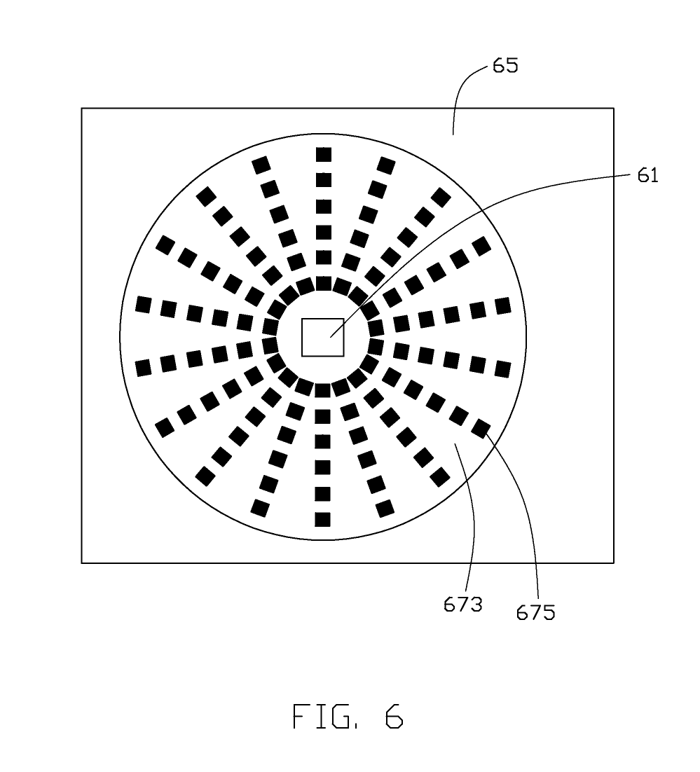

FIG. 6 illustrates a fifth embodiment of the backlight module 60. The difference between the backlight module 60 and the backlight module 20 is the pattern 675. A density of the patterns 675 in the corresponding predetermined region 673 is grandly decreased along a radius direction. The patterns 675 form a series of concentric rings centered on the corresponding light source 61. Each of the rings is formed by a common quantity of the patterns 675. The density of the patterns 675 away from the corresponding light source 61 is less than the density of the patterns 675 adjacent to the corresponding light source 61. The pattern 675 is substantially a square shaped. A side of the pattern 675 is in a range between 0.3-0.7 mm.

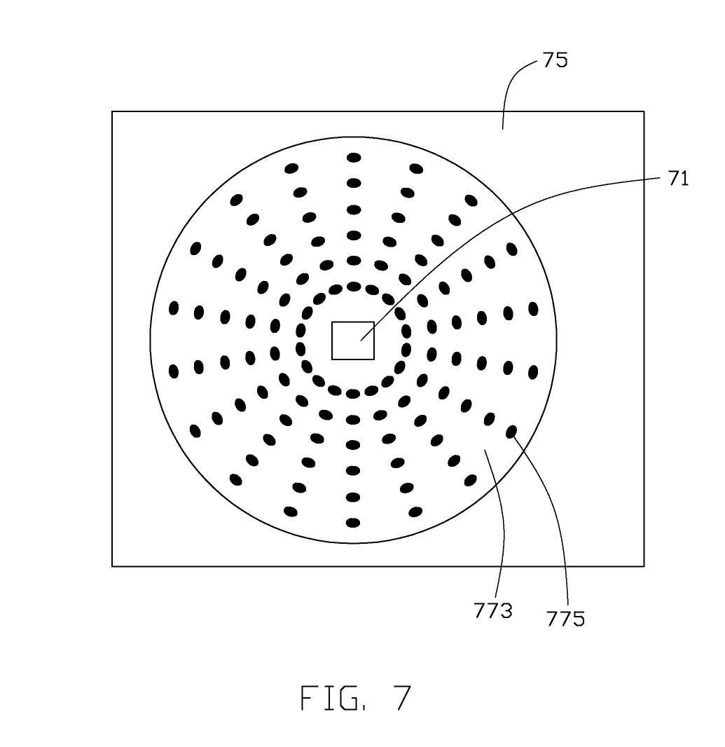

FIG. 7 illustrates a sixth embodiment of the backlight module 70. The difference between the backlight module 70 and the backlight module 20 is the pattern 775. A density of the patterns 775 in the corresponding predetermined region 773 is grandly decreased along a radius direction. The patterns 775 form a series of concentric rings centered on the corresponding light source 71. Each of the rings is formed by a common quantity of the patterns 775. The density of the patterns 775 away from the corresponding light source 71 is less than the density of the patterns 775 adjacent to the corresponding light source 71. The pattern 775 is substantially an ellipse shaped. A major axis and a minor axis of the pattern 775 are in a range between 0.1-0.7 mm

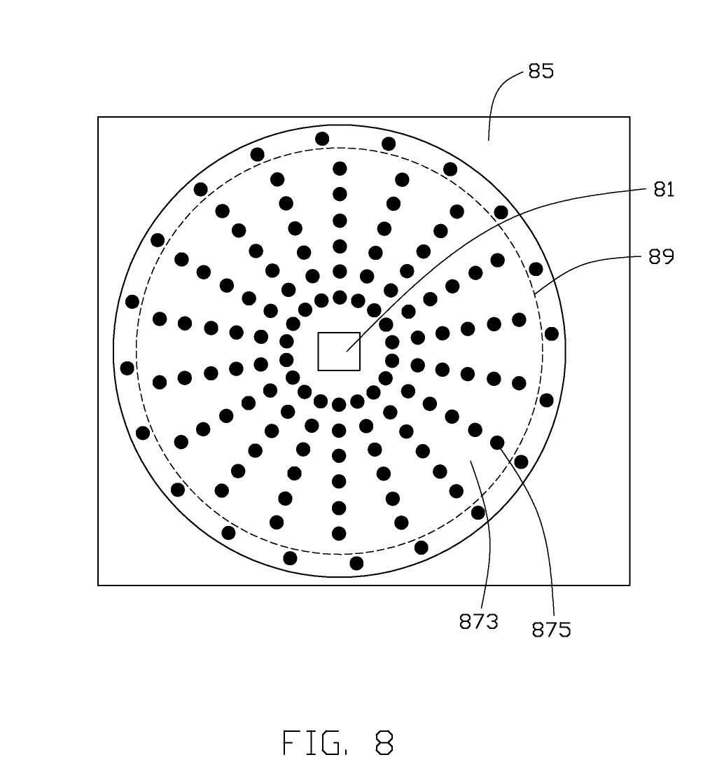

FIG. 8 illustrates a seventh embodiment of the backlight module 80. The difference between the backlight module 80 and the backlight module 20 is the predetermined region 873. A projection of the optical element 83 on the circuit board 85 is contained in corresponding predetermined region 873, which cause parts of the patterns 875 to be outside of the projection of the optical element 83. In other embodiments, two adjacent predetermined regions 873 are partly overlapping with each other.

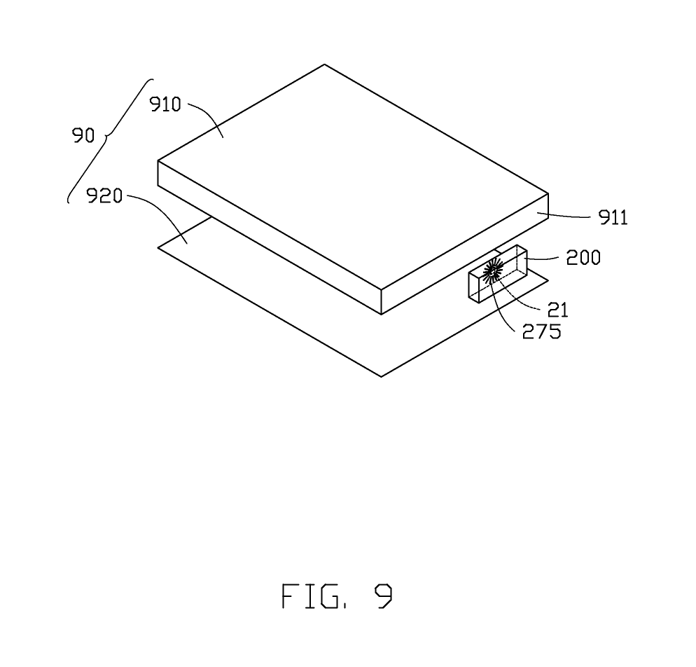

FIG. 9 illustrates a second embodiment of the display apparatus 900. The display apparatus 900 includes a substantially plate shaped light guide 910, a reflector 920 located on a bottom surface of the light guide 910, and a plurality of light bars 200 located on a side of the light guide 910. The light guide 910 includes a plurality of incident surfaces 911. The incident surfaces 911 correspond to the light bars 200 in a one-to-one relationship.

Based on the patterns on the circuit board located in the predetermined region corresponding to the optical element, a transmitting parameter of the light illuminated on the circuit board is adjusted. Therefore, uniformity of the light illuminated on the display panel is improved, and a thickness of the display apparatus is decreased.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A backlight module for providing backlight to a display panel, the backlight module comprising:
a plurality of light sources;
a plurality of optical elements corresponding to the light sources; and
a circuit board configured to electrically connect to the light sources, and having defined therein a plurality of predetermined regions corresponding to the optical elements;
wherein each of the predetermined regions comprises a plurality of patterns on an upper surface of the circuit board, each pattern in a same predetermined region forms a series of concentric rings centered on the corresponding light source, and each pattern is configured to adjust a transmitting parameter of light transmitted by at least one light source from amongst the plurality of light sources.

2. The backlight module of claim 1, wherein the pattern adjusts a scattering angle of the light.

3. The backlight module of claim 1, wherein the pattern adjusts a reflectivity of the light.

4. The backlight module of claim 1, wherein a projection of the optical element on the circuit board is completely overlapping with the corresponding predetermined region.

5. The backlight module of claim 1, wherein a projection of the optical element on the circuit board is contained in corresponding predetermined region, which cause parts of the patterns to be outside of the projection of the optical element.

6. The backlight module of claim 1, wherein each of the rings is formed by a common quantity of the patterns.

7. The backlight module of claim 1, wherein quantities of the patterns forming the concentric rings are decreased along a radius direction; the quantity of the patterns forming the ring adjacent to the corresponding light source is larger than the quantity of the patterns forming the ring away from the corresponding light source.

8. The backlight module of claim 1, wherein diameters of the patterns on the same ring is equal to each other; diameters of the patterns on the rings along a radius direction centered on the corresponding light source are grandly decreased; the diameter of the patterns forming the ring adjacent to the corresponding light source is larger than the diameter of the patterns forming the ring away from the corresponding light source.

9. The backlight module of claim 1, wherein a density of the patterns in the predetermined region is in a range between 10%-15%.

10. The backlight module of claim 1, wherein a diameter of the pattern is in a range between 0.3-0.7 mm.

11. A display apparatus comprising:
a display panel;
a backlight module configured to provide backlight to the display panel, and the backlight module comprising:
a plurality of light sources;
a plurality of optical elements corresponding to the light sources, and located on a light transmitting path of the corresponding light source; and
a circuit board configured to electrically connect to the light sources, and define a plurality of predetermined regions corresponding to the optical elements;
wherein each of the predetermined regions comprises a plurality of patterns on an upper surface of the circuit board; the patterns in the same predetermined region form a series of concentric rings centered on the corresponding light source; the patterns adjusts a transmitting parameter of the light to be reflected by the corresponding predetermined region.

12. The display apparatus of claim 11, wherein the pattern adjusts a scattering angle of the light.

13. The display apparatus of claim 11, wherein the pattern adjusts a reflectivity of the light.

14. The display apparatus of claim 11, wherein a projection of the optical element on the circuit board is completely overlapping with the corresponding predetermined region.

15. The display apparatus of claim 11, wherein a projection of the optical element on the circuit board is contained in corresponding predetermined region, which cause parts of the patterns to be outside of the projection of the optical element.

16. The display apparatus of claim 11, wherein each of the rings is formed by a common quantity of the patterns.

17. The display apparatus of claim 11, wherein quantities of the patterns forming the concentric rings are decreased along a radius direction; the quantity of the patterns forming the ring adjacent to the corresponding light source is larger than the quantity of the patterns forming the ring away from the corresponding light source.

18. The display apparatus of claim 11, wherein diameters of the patterns on the same ring is equal to each other; diameters of the patterns on the rings along a radius direction centered on the corresponding light source are grandly decreased; the diameter of the patterns forming the ring adjacent to the corresponding light source is larger than the diameter of the patterns forming the ring away from the corresponding light source.

19. The display apparatus of claim 11, wherein a density of the patterns in the predetermined region is in a range between 10%-15%.

20. The backlight module of claim 11, wherein a diameter of the pattern is in a range between 0.3-0.7 mm.
